(19) United States
(12) Patent Application Publication
(10) Pub. No.: US 2026/0058576 A1
(43) Pub. Date: Feb. 26, 2026

(54) PIEZOELECTRIC ACTUATOR AND ELECTRONIC DEVICE

(71) Applicant: Luxshare Intelligent Manufacture Technology (Changshu) Co., Ltd, Changshu City (CN)

(72) Inventor: Po-Ying TSENG, Changshu City (CN)

(73) Assignee: Luxshare Intelligent Manufacture Technology (Changshu) Co., Ltd, Changshu City (CN)

(21) Appl. No.: 18/968,359

(22) Filed: Dec. 4, 2024

(30) Foreign Application Priority Data
Aug. 26, 2024 (CN) 202411178167.7

(51) Int. Cl. H02N 2/10

(52) U.S. Cl. CPC H02N 2/103

(57) ABSTRACT

A piezoelectric actuator includes a fixed component, a piezoelectric component, a swing member and a movable member. The piezoelectric component is arranged on the fixed component, and the piezoelectric component has a first friction surface. One end of the swing member is rotatably connected to the fixed component, and the swing member is provided with a second friction surface abutting against the first friction surface. The movable member is movably connected to the other end of the swing member. The piezoelectric component is configured to drive the swing member through the abutting first friction surface and the second friction surface to swing relative to the fixed component, to drive the movable member to move.

### CROSS-REFERENCE TO RELATED APPLICATION(S)

This application claims priority to Chinese Patent Application No. 202411178167.7 filed Aug. 26, 2024, the disclosure of which is incorporated herein by reference in its entirety.

### TECHNICAL FIELD

The present application relates to the field of piezoelectric actuator technology, and in particular to a piezoelectric actuator and an electronic device.

### BACKGROUND

Piezoelectric actuators are generally applied in electronic devices such as Augmented Reality (AR), Virtual Reality (VR) and camera modules. Piezoelectric actuators are used to drive the displacement, deformation, etc. of optical modules, switches, reeds or any components, and have high stability.

In the prior art, a piezoelectric actuator includes a fixed part, a piezoelectric component arranged on the fixed part, and a movable member contacting the piezoelectric component. The piezoelectric component causes the piezoelectric material to deform through voltage changes, so that the piezoelectric component contacts the friction surface on the movable member and pushes the movable member to move in a specific direction. However, in order to ensure that the friction surface of the movable member always contacts the piezoelectric component during the movement of the movable member, the size of the movable member needs to be large, generally greater than or equal to the size of the piezoelectric component plus twice a required stroke, and a space of at least one time a stroke needs to be reserved in front and behind the movable member in a particular direction for the movable member to use, resulting in the piezoelectric actuator in the prior art being large in size and hardly to be used in electronic devices with high space requirements.

Therefore, a piezoelectric actuator and an electronic device are urgently needed to solve the above problems.

### SUMMARY

The embodiments of the present application provide a piezoelectric actuator and an electronic device.

A piezoelectric actuator, includes: a fixed component, a piezoelectric component, a swing member and a movable member.

The piezoelectric component is arranged on the fixed component, and the piezoelectric component has a first friction surface.

One end of the swing member is rotatably connected to the fixed component, and the swing member is provided with a second friction surface abutting against the first friction surface.

The movable member is movably connected to the other end of the swing member.

The piezoelectric component is configured to drive the swing member to swing relative to the fixed component through the abutting first friction surface and the second friction surface, to drive the movable member to move.

In some embodiments, a first end of the swing member is rotatably connected to the fixed component. One of the movable member and a second end of the swing member facing away from the first end is provided with a slide slot, and the other one of the movable member and the second end of the swing member arranged away from the first end is provided with a guide member slidably matched with the slide slot. The guide member is slidable in an extension direction of the slide slot, to allow a moving trajectory of the movable member to be a straight line when the swing member rotates.

In some embodiments, the movable member is slidably connected to the fixed component in a first direction, and a position of the rotatable connection of the first end of the swing member to the fixed component is located in the middle of the fixed component in the first direction.

In some embodiments, the piezoelectric actuator further includes a guide structure connected to the fixed component and extending in the first direction. The movable member is provided with a guide matching structure slidably matching the guide structure, and the movable member is slidably arranged on the guide structure through the guide matching structure.

In some embodiments, two ends of the guide structure in the first direction are respectively connected to two side walls of the fixed component opposite to each other in the first direction, the guide matching structure is a sliding hole provided in the movable member, and the guide structure is arranged to enter the sliding hole.

In some embodiments, the swing member includes a first connecting portion, a rocker arm and a cantilever. The first connecting portion is movably connected to the movable member, the rocker arm and the cantilever are connected to the same side of the first connecting portion, and the rocker arm is arranged spaced apart from the cantilever. One end of the cantilever facing away from the first connecting portion is rotatably connected to the fixed component; and the second friction surface is arranged on the rocker arm.

In some embodiments, two cantilevers are provided, and the two cantilevers are arranged on opposite sides of the rocker arm. The swing member further includes a second connecting portion. Ends of the two cantilevers facing away from the first connecting portion are both connected to the second connecting portion, and the second connecting portion is rotatably connected to the fixed component.

In some embodiments, the fixed component includes a housing and a fixed part arranged in the housing. The piezoelectric actuator further includes a rotating shaft arranged on a first surface of the fixed part, and the second connecting portion is sleeved on the rotating shaft and is rotatable around the rotating shaft.

The swing member has an unassembled state and an assembled state. When the swing member is in the unassembled state, a gap is present between the second connecting portion and the first surface; and when the swing member is in the assembled state, a pressing member further included in the piezoelectric actuator is connected to the housing and presses the second connecting portion to abut against the fixed part, to allow a pre-pressure to present between the rocker arm and the piezoelectric component.

In some embodiments, the fixed component, the piezoelectric component, the swing member and the movable member are all located in the housing.

A preset wall surface of the housing is provided with a connecting hole, an orthographic projection of the movable member on the preset wall surface at least partially falls into the connecting hole, and the connecting hole is configured for a moving member connected to the movable member to pass through.

In some embodiments, the piezoelectric actuator further includes a first magnetic member arranged on the fixed component. The swing member is made of a magnetic conductive material, the first magnetic member and the piezoelectric component are arranged on the same side of the swing member, and the first magnetic member is magnetically matchable with the swing member to drive the first friction surface to always abut against the second friction surface.

Alternatively, the piezoelectric actuator further includes a second magnetic member and a third magnetic member. The second magnetic member is arranged on the fixed component, the third magnetic member is arranged on the swing member, the second magnetic member and the piezoelectric component are arranged on a same side of the swing member, and the second magnetic member and the third magnetic member are magnetically attracted and matched to drive the first friction surface to always abut against the second friction surface.

In some embodiments, the swing member is an integrated plate-like structure.

In some embodiments, the first friction surface is an arc surface.

In some embodiments, the piezoelectric component includes a piezoelectric member and a linkage member arranged on the piezoelectric member.

The linkage member is in a cylindrical shape, and an outer peripheral surface of the linkage member is the first friction surface; or, the linkage member has a flat connecting surface parallel to and connected to the piezoelectric member, and the first friction surface is arranged opposite to the flat connecting surface.

Embodiments of the present application further provide an electronic device.

The electronic device, includes the piezoelectric actuator as described above.

### BRIEF DESCRIPTION OF DRAWINGS

In order to more clearly illustrate the technical solutions in the embodiments of the present application, the drawings required for the description of the embodiments of the present application are briefly introduced below. Obviously, the drawings described below are only some embodiments of the present application. For a person of ordinary skills in the art, other drawings can be obtained based on the contents of the embodiments of the present application and these drawings without making creative efforts.

FIG. 1 is a top view of a piezoelectric actuator provided in one or more embodiments of the present application;

FIG. 2 is a reference view of a piezoelectric actuator in use provided in one or more embodiment of the present application;

FIG. 3 is an exploded view of a piezoelectric actuator provided in one or more embodiments of the present application;

FIG. 4 is a schematic structural diagram of a swing member provided in one or more embodiments of the present application;

FIG. 5 is a sectional view one of a piezoelectric actuator provided in one or more embodiments of the present application;

FIG. 6 is a sectional view two of a piezoelectric actuator provided in one or more embodiment of the present application;

FIG. 7 is a schematic diagram of the deformation amount of a swing member provided in one or more embodiments of the present application;

FIG. 8 is a schematic diagram of a piezoelectric component provided in one or more embodiments of the present application;

FIG. 9 is a schematic diagram of an electronic device applying a piezoelectric actuator provided in one or more embodiments of the present application;

FIG. 10 is a schematic diagram of another electronic device applying a piezoelectric actuator provided in one or more embodiments of the present application;

FIG. 11 is a schematic diagram of another electronic device applying a piezoelectric actuator provided in one or more embodiments of the present application;

FIG. 12 is a schematic structural diagram of another piezoelectric actuator provided in one or more embodiments of the present application;

FIG. 13 is an exploded view of another piezoelectric actuator provided in one or more embodiments of the present application; and

FIG. 14 is a schematic diagram of another piezoelectric component provided in one or more embodiments of the present application.

### REFERENCE SIGNS LIST

10 piezoelectric actuator
100 fixed component
110 housing
111 connecting hole
120 fixed part
121 first surface
200 piezoelectric component
201 first friction surface
210 piezoelectric member
220 linkage member
221 flat connecting surface
300 swing member
301 second friction surface
310 slide slot
320 first connecting portion
330 rocker arm
340 cantilever
350 second connecting portion
360 through hole
400 movable member
410 guide member
500 guide structure
600 rotating shaft
700 gap
800 first magnetic member
20 device body
30 moving member
X first direction
Y second direction

### DETAILED DESCRIPTION

In order to make the technical problems solved, the technical solutions adopted and the technical effects achieved by the present application clearer, the technical solutions of the present application are further explained in conjunction with the drawings and through embodiments. It can be understood that the embodiments described here are only intended to explain the present application, rather than limiting the present application. It should also be noted that, for the convenience of description, only the parts related to the present application rather than all are shown in the drawings.

It is to be noted that similar reference numerals and letters represent similar terms in the following drawings. Therefore, once an item is defined in a drawing, it does not need to be further defined or explained in subsequent drawings.

In the description of the present application, it is to be noted that, unless otherwise expressly specified and limited, the terms “connected to each other”, “connected” or “fixed” are to be construed in a broad sense, for example, as permanently connected or detachably connected or integrally formed; mechanically connected or electrically connected; directly connected to each other or indirectly connected to each other via an intermediary; or internally connection of two components or interaction relationship between two components. For those of ordinary skill in the art, specific meanings of the preceding terms in the present application may be construed based on specific situations.

In the present application, unless otherwise expressly specified and limited, when a first feature is described as “above” or “below” a second feature, the first feature and the second feature may be in direct contact, or be in contact via another feature between the two features. Moreover, when the first feature is described as “on”, “above” or “over” the second feature, the first feature is right on, above or over the second feature or the first feature is obliquely on, above or over the second feature; or the first feature is simply at a higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature. In the description of the embodiments, unless otherwise specified, “multiple” specifically refers to two or more.

In the description of this article, it should be understood that the orientation or position relationships indicated by the terms such as “upper”, “lower”, “left”, “right”, etc., are based on the orientation or position relationship shown in the drawings, which is only for the convenience of description and simplification of operation, and does not indicate or imply that the device or element referred to must have a specific orientation, be constructed and operated in a specific orientation, and therefore cannot be understood as a limitation of the present application. Furthermore, the terms “first” and “second” are only used to distinguish in the description and have no special meaning.

It should be noted that when an element is referred to as being “fixed to” or “set on” another element, it may be directly on the other element or there may be a central element.

### Embodiment One

A piezoelectric actuator is provided according to this embodiment which can have a smaller size, lower installation space requirements, and a wider range of applications.

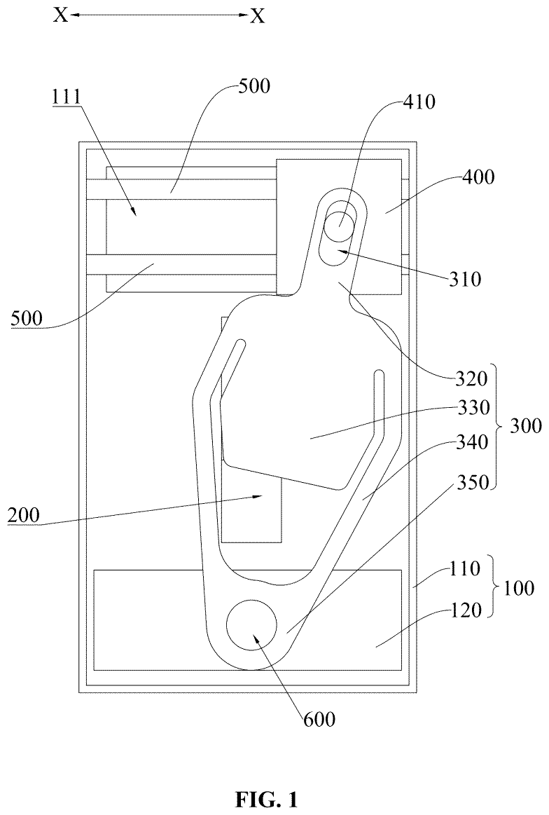

As shown in FIG. 1 to FIG. 8, a piezoelectric actuator 10 includes a fixed component 100, a piezoelectric component 200, a swing member 300, and a movable member 400.

In this embodiment, the fixed component 100 is configured to be fixed on a fixed structure of an electronic device. For example, as shown in FIG. 1, the fixed component 100 may be in the shape of a rectangular parallelepiped, or the fixed component 100 may also be in other shapes, which is not limited in this embodiment.

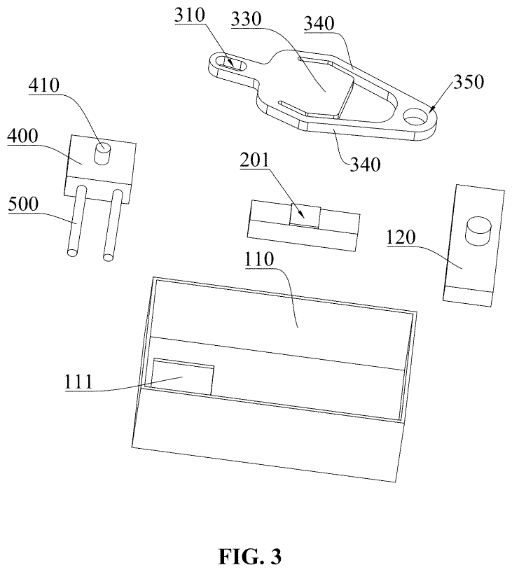

As shown in FIG. 1, the piezoelectric component 200 is arranged on the fixed component 100. Exemplarily, a part of the piezoelectric component 200 is connected to the fixed component 100, and another part of the piezoelectric component 200 is not connected to the fixed component 100 and is movable relative to the fixed component 100, so that the piezoelectric component 200 can be deformed after being energized. Alternatively, the piezoelectric component 200 can be movably arranged in the fixed component 100, and the fixed component 100 limits the maximum range of motion of the piezoelectric component 200, but does not affect the deformation of the piezoelectric component 200. As shown in FIG. 3, the piezoelectric component 200 has a first friction surface 201. Exemplarily, the friction coefficient of the first friction surface 201 can be relatively large.

Please continue to refer to FIG. 1, one end of the swing member 300 is rotatably connected to the fixed component 100, so that the swing member 300 can swing relative to the fixed component 100. The swing member 300 is provided with a second friction surface 301 that is always in contact with the first friction surface 201, so that when the piezoelectric component 200 moves, the swing member 300 is driven to move by the abutting first friction surface 201 and second friction surface 301. Exemplarily, the second friction surface 301 is provided in the middle of a surface of the swing member 300 facing the piezoelectric component 200. The friction coefficient of the second friction surface 301 can be relatively large.

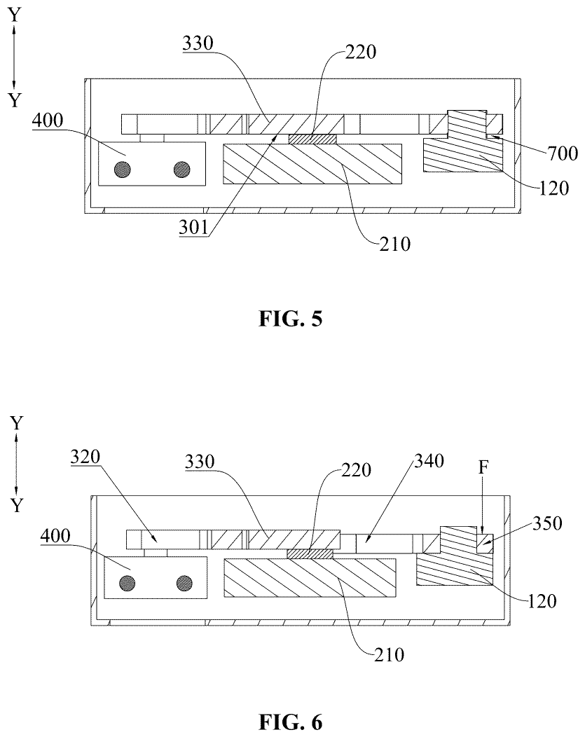

Exemplarily, the swing member 300 has a length direction and a thickness direction, and one end of the swing member 300 in the length direction is rotatably connected to the fixed component 100. The second friction surface 301 is provided on one side of the swing member 300 in the thickness direction, and the swing member 300 and the piezoelectric component 200 are arranged opposite to each other in the thickness direction of the swing member 300. Exemplarily, as shown in FIG. 5 and FIG. 6, the thickness direction of the swing member 300 is a second direction Y.

Exemplarily, the movable member 400 is movably connected to the other end of the swing member 300, and when the swing member 300 swings, the swing member 300 can drive the movable member 400 to move.

In this embodiment, the piezoelectric component 200 is configured to drive the swing member 300 to swing relative to the fixed component 100 through the abutting first friction surface 201 and the second friction surface 301, so as to drive the movable member 400 to move relative to the fixed component 100. Exemplarily, the piezoelectric component 200 can drive the swing member 300 to swing back and forth relative to the fixed component 100, so that the movable member 400 can move back and forth relative to the fixed component 100.

When using the piezoelectric actuator 10 provided in this embodiment, the fixed component 100 is fixed on the fixed structure of the electronic device, and a moving member 30 to be driven of the electronic device is connected to the movable member 400. The piezoelectric component 200 can be connected to a controller of the electronic device in a communication manner, and the controller transmits a piezoelectric signal to the piezoelectric component 200, so that the piezoelectric component 200 produces a preset deformation. For example, in this embodiment, the piezoelectric component 200 vibrates and deforms in the second direction Y. Of course, it can be understood that the piezoelectric component 200 can also deform in other directions, which is not limited in this embodiment. After the piezoelectric component 200 is deformed, the friction between the first friction surface 201 and the second friction surface 301 is used to drive the swing member 300 to swing. Since one end of the swing member 300 is rotatably connected to the fixed component 100, the other end of the swing member 300 will be displaced, thereby driving the movable member 400 to be displaced relative to the fixed component 100. The movable member 400 brings the moving member 30 of the electronic device to be displaced, thereby driving the moving member 30.

In the piezoelectric actuator 10 provided in this embodiment, the piezoelectric component 200 has a first friction force, the swing member 300 is provided with the second friction surface 301 abutting against the first friction surface 201, one end of the swing member 300 is rotatably connected to the fixed component 100, and the other end of the swing member 300 is movably connected to the movable member 400. When the piezoelectric component 200 is energized and deformed, the abutting first friction surface 201 and second friction surface 301 can be used to drive the swing member 300 to swing relative to the fixed component 100, so as to drive the movable member 400 to move through the swing member 300, thereby realizing indirect driving of the movable member 400. Since the movable member 400 does not directly contact the piezoelectric component 200, the movable member 400 has a smaller size, and the movable member 400 does not need to reserve a space greater than one time the stroke for its use. The stroke of the movable member 400 can be just equal to the moving distance required to drive the moving member 30 to move, so that the swing amplitude of the swing member 300 will not be too large, and the required activity space is smaller. In addition, by providing the swing member 300, the movable member 400 can be located on one side of the piezoelectric component 200 in the length direction of the swing member 300, so that in the thickness direction of the swing member 300, the size of the piezoelectric actuator 10 can be smaller, and thus the piezoelectric actuator 10 can have a smaller overall size which meets the miniaturization requirements, and can be used in scenes with smaller installation space, and has a wider range of applications.

In some optional embodiments, the swing member 300 has a first end in the length direction and a second end facing away from the first end. The first end of the swing member 300 is rotatably connected to the fixed component 100, and one of the second end of the swing member 300 and the movable member 400 is provided with a slide slot 310, and the other of the second end of the swing member 300 and the movable member 400 is provided with a guide member 410 that is slidably matched with the slide slot 310. The guide member 410 is capable of sliding in the extension direction of the slide slot 310, so that when the swing member 300 rotates, a moving trajectory of the movable member 400 is a straight line. For example, the moving trajectory of the movable member 400 extends in a first direction X. For example, the first direction X is the width direction of the fixed component 100.

In this embodiment, as shown in FIG. 3, the slide slot 310 is disposed on the second end of the swing member 300, and the guide member 410 is disposed on the movable member 400. It should be noted that the guide member 410 in this embodiment is able to rotate and slide in the slide slot 310 so as not to get stuck. For example, the guide member 410 may be a cylinder.

In some other optional embodiments, the swing member 300 may also be provided with a hole for the guide member 410 to pass through rather than the slide slot 310, and the guide member 410 is capable of rotating in the hole. In this case, the moving trajectory of the movable member 400 is an arc.

Optionally, the movable member 400 is slidably connected to the fixed component 100 in the first direction X to improve the stability and direction accuracy of the movement of the movable member 400. In this embodiment, the position of the rotatable connection of the swing member 300 to the fixed component 100 is located in the middle of the fixed component 100 in the first direction X, so that the fixed component 100 has a smaller size in the first direction X, which facilitates the miniaturization of the piezoelectric actuator 10.

There are multiple ways for the movable member 400 to be slidably connected to the fixed component 100. Exemplarily, the piezoelectric actuator 10 further includes a guide structure 500, and the guide structure 500 is connected to the fixed component 100 and is configured to extend in the first direction X. The movable member 400 is provided with a guide matching structure that slidably matches the guide structure 500, and the movable member 400 is slidably arranged on the guide structure 500 in the first direction X through the guide matching structure to achieve the sliding connection between the movable member 400 and the fixed component 100.

In some optional embodiments, as shown in FIG. 3, two ends of the guide structure 500 in the first direction X are respectively connected to two opposite side walls of the fixed component 100 in the first direction X, the guide matching structure is a sliding hole provided in the movable member 400, and the guide structure 500 is arranged to enter the sliding hole, so that upper and lower surfaces of the movable member 400 will not be occupied by the guide matching structure, the guide member 410 may be provided on the upper surface of the movable member 400, and the lower surface of the movable member 400 is used to connect the moving member 30 of the electronic device, thereby preventing the connection between the moving member 30 and the movable member 400 from interfering with the guide matching structure or the guide structure 500.

For example, as shown in FIG. 3, the guide structure 500 may be a guide column, and correspondingly, the guide matching structure is a sliding hole extending through the movable member 400 in the first direction X, and the guide column is configured to pass through the sliding hole. Alternatively, the guide structure 500 may further be a slide rail arranged on the fixed component 100, and the guide matching structure is a slide slot 310 that is slidably matched with the slide rail, and the slide slot 310 is provided in the movable member 400, which is not limited in this embodiment.

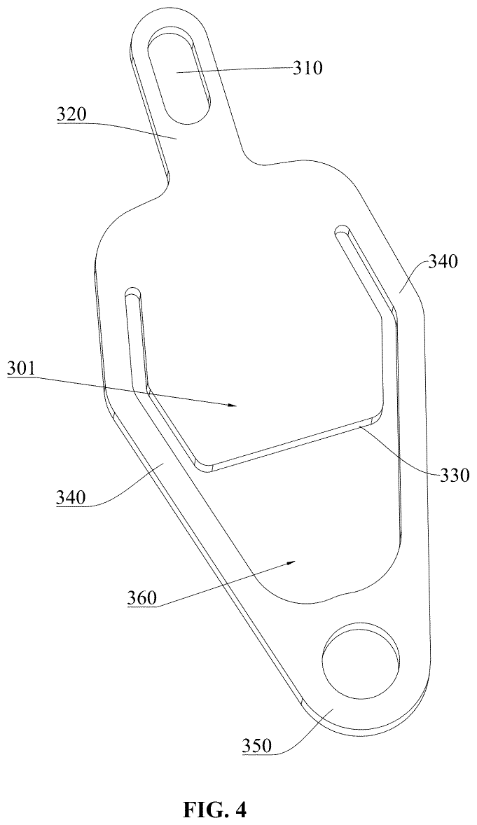

For example, as shown in FIG. 3 and FIG. 4, the swing member 300 includes a first connecting portion 320, a rocker arm 330 and a cantilever 340. The first connecting portion 320 is movably connected to the movable member 400, that is, the slide slot 310 is provided in the first connecting portion 320. The rocker arm 330 and the cantilever 340 are connected to the same side of the first connecting portion 320, and the rocker arm 330 and the cantilever 340 are arranged spaced apart from each other, so that there is a gap between the rocker arm 330 and the cantilever 340, and thus the cantilever 340 can move relative to the rocker arm 330 under the action of an external force. Optionally, the rocker arm 330 and the cantilever 340 are arranged to be spaced apart in the width direction of the rocker arm 330 (that is, the first direction X).

Exemplarily, one end of the cantilever 340 facing away from the first connecting portion 320 is rotatably connected to the fixed component 100.

In this embodiment, the second friction surface 301 is provided on the rocker arm 330, for example, the second friction surface 301 is provided on one side of the rocker arm 330 in the thickness direction (i.e., the second direction Y). Specifically, the surface of the rocker arm 330 facing the piezoelectric component 200 is the second friction surface 301. When the piezoelectric component 200 drives the rocker arm 330 to move through the abutting first friction surface 201 and second friction surface 301, the rocker arm 330 drives the first connecting portion 320 and the cantilever 340 to swing, so that the first connecting portion 320 drives the movable member 400 to move relative to the fixed component 100.

It is to be noted that the width of the rocker arm 330 is much larger than the width of the cantilever 340, so that the second friction surface 301 is large, thereby ensuring that the second friction surface 301 can effectively contact the first friction surface 201.

Further optionally, as shown in FIG. 4, two cantilevers 340 are provided, and the two cantilevers 340 are arranged on opposite sides of the rocker arm 330 in the first direction X, so that in the thickness direction of the rocker arm 330, the two cantilevers 340 and the rocker arm 330 can move relative to each other. In this manner, in one aspect, the flexibility of the piezoelectric actuator 10 is improved, and in another aspect, force is applied to the rocker arm 330 through the cantilever 340, so that the rocker arm 330 does not damage the piezoelectric component 200 on the basis of ensuring its contact with the piezoelectric component 200, thereby improving the structural reliability.

Please continue to refer to FIG. 4. The swing member 300 further includes a second connecting portion 350. Ends of the two cantilevers 340 facing away from the first connecting portion 320 are both connected to the second connecting portion 350. The second connecting portion 350 is rotatably connected to the fixed component 100. By providing the second connecting portion 350, the rotatable connection between the swing member 300 and the fixed component 100 is facilitated.

For example, as shown in FIG. 4, the length of the rocker arm 330 is less than the length of the cantilever 340, so that the rocker arm 330 can be smaller in size on the basis of fully contacting the piezoelectric component 200, which is conducive to the lightweight of the piezoelectric actuator 10. In this embodiment, the rocker arm 330, the two cantilevers 340 and the second connecting portion 350 are arranged to surround a through hole 360.

In this embodiment, one end of the rocker arm 330 is connected to the first connecting portion 320, and the other end of the rocker arm 330 is a free end to form a cantilever beam structure. In this embodiment, the connection position of the cantilever 340 to the first connecting portion 320 is located between the second friction surface 301 and the connection position of the first connecting portion 320 to the movable member 400, and the rocker arm 330 can rotate slightly around the first connecting portion 320, so that the second friction surface 301 can be kept as a plane as much as possible, to allow the pre-compression positive force between the rocker arm 330 and the piezoelectric component 200 to be relatively stable, so that the second friction surface 301 provided on the rocker arm 330 can better maintain the state of abutting against the first friction surface 201, and can also better match the dimensional error of the piezoelectric component 200 to ensure the driving effect.

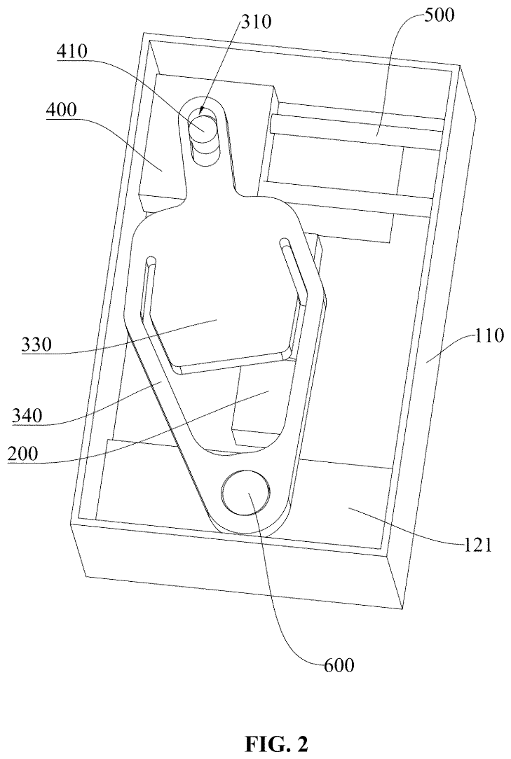

For example, as shown in FIG. 2, the fixed component 100 includes a housing 110 and a fixed part 120 arranged in the housing 110. The piezoelectric actuator 10 further includes a rotating shaft 600 arranged on a first surface 121 of the fixed part 120, and the second connecting portion 350 is sleeved on the rotating shaft 600 and is rotatable around the rotating shaft 600.

In this embodiment, the swing member 300 has an unassembled state and an assembled state. FIG. 5 is a sectional view of the piezoelectric actuator 10 when the swing member 300 is in an unassembled state; and FIG. 6 is a sectional view of the piezoelectric actuator 10 when the swing member 300 is in an assembled state.

When the swing member 300 is in the unassembled state, as shown in FIG. 5, a gap 700 is present between the second connecting portion 350 and the first surface 121, that is, the second connecting portion 350 is not in contact with the fixed part 120. When the swing member 300 is in the assembled state, a pressing member further included in the piezoelectric actuator 10 is connected to the housing 110 and presses the second connecting portion 350 to abut against the first surface 121 of the fixed part 120, to allow a pre-pressure to present between the rocker arm 330 and the piezoelectric component 200. The pre-pressure is the force transmitted to the rocker arm 330 by the second connecting portion 350 through the cantilever 340 and the first connecting portion 320. The pre-pressure enables friction to be generated between the rocker arm 330 and the piezoelectric component 200, thereby ensuring the effect of the piezoelectric component 200 driving the rocker arm 330 to move. The direction of the external force F applied by the pressing member to the second connecting portion 350 is the direction shown in FIG. 6. For example, when the length of the gap 700 in the second direction Y is 0.03 mm, a pre-pressure of 2.5 N can be generated between the rocker arm 330 and the piezoelectric component 200.

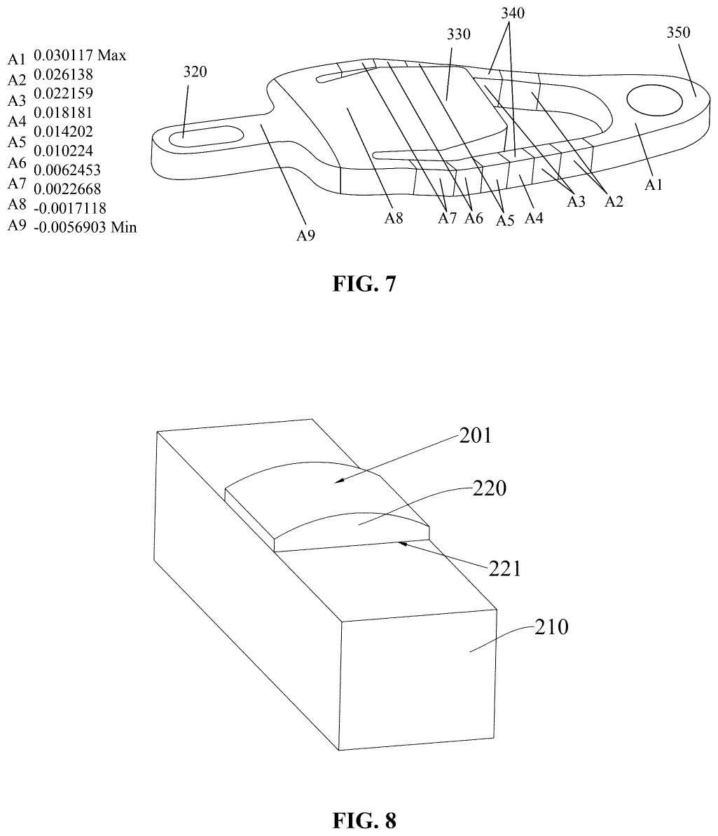

FIG. 7 is a distribution diagram of the deformation amount of the swing member 300 provided in this embodiment after being pressed by the pressing member. It can be seen from FIG. 7 that the cantilever 340 and the second connecting portion 350 are both greatly deformed, and the deformation amount of the swing arm 330 and the first connecting portion 320 is small, but the force transmitted to the swing arm 330 can still meet the requirements of making the swing arm 330 tightly abut against the piezoelectric component 200.

For example, as shown in FIG. 2, FIG. 5 and FIG. 6, the fixed component 100, the piezoelectric component 200, the swing member 300 and the movable member 400 are all located in the housing 110, so that they can be protected by the housing 110, and the movement limit of the swing member 300 and the movable member 400 can also be limited by the side wall of the housing 110, realizing the multi-usages of the housing 110.

For another example, as shown in FIG. 3, a preset wall surface of the housing 110 is provided with a connecting hole 111, and the orthographic projection of the movable member 400 on the preset wall surface at least partially falls into the connecting hole 111. The connecting hole 111 is configured for the moving member 30 connected to the movable member 400 to pass through. The moving member 30 passes through the connecting hole 111 and is connected to the movable member 400, so that when moving, the movable member 400 drives the moving member 30 to move.

For example, as shown in FIG. 8, the first friction surface 201 on the piezoelectric component 200 is an arc surface to avoid damaging the swing member 300, and the contact area between the first friction surface 201 and the second friction surface 301 can be changed with the magnitude of the force between the piezoelectric component 200 and the swing member 300. For example, the greater the force between the piezoelectric component 200 and the swing member 300, the greater the contact area between the first friction surface 201 and the second friction surface 301, the better the driving effect, which achieves a high flexibility. For example, in the width direction of the swing member 300, the distance between the arc surface and the swing member 300 first decreases, decreases to 0, and then increases.

Optionally, as shown in FIG. 8, the piezoelectric component 200 includes a piezoelectric member 210 and a linkage member 220 arranged on the piezoelectric member 210. The piezoelectric member 210 is made of piezoelectric material, and the material of the linkage member 220 can be a common plastic material, such as plastic. It should be noted that for the specific structure of the piezoelectric member 210, reference may be made to the piezoelectric block in the prior art, as long as the corresponding function can be achieved, which is not described in detail here in this embodiment.

For example, please refer to FIG. 8, the linkage member 220 has a flat connecting surface 221 that is parallel to and connected to the piezoelectric member 210, the first friction surface 201 is arranged opposite to the flat connecting surface 221, and the flat connecting surface 221 of the linkage member 220 for contacting the piezoelectric member 210 has a larger area, which can improve the connection reliability between the linkage member 220 and the piezoelectric member 210 and reduce the probability of separation between the two.

An electronic device is further provided according to this embodiment, which includes the piezoelectric actuator 10 as described above. The electronic device provided in this embodiment needs to reserve a small installation space for the piezoelectric actuator 10, and has a high flexibility.

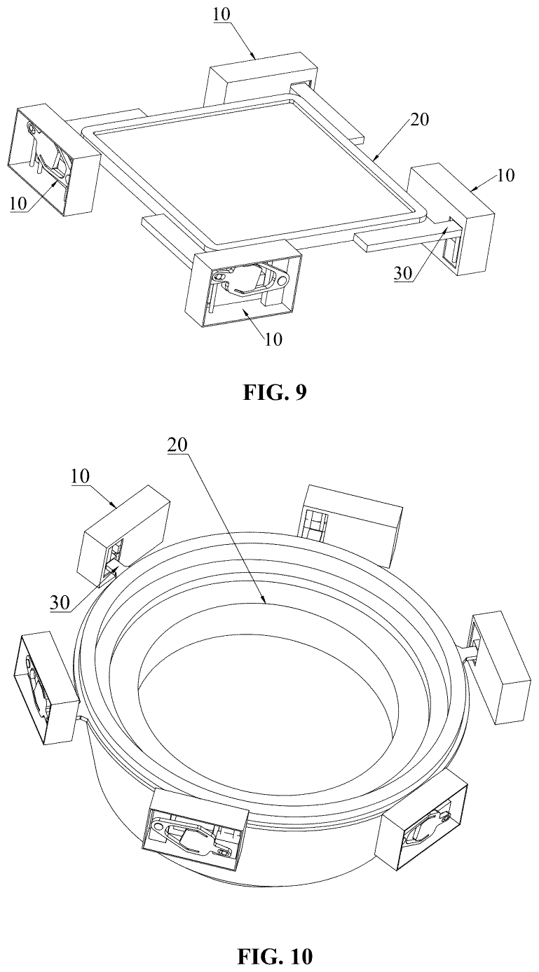

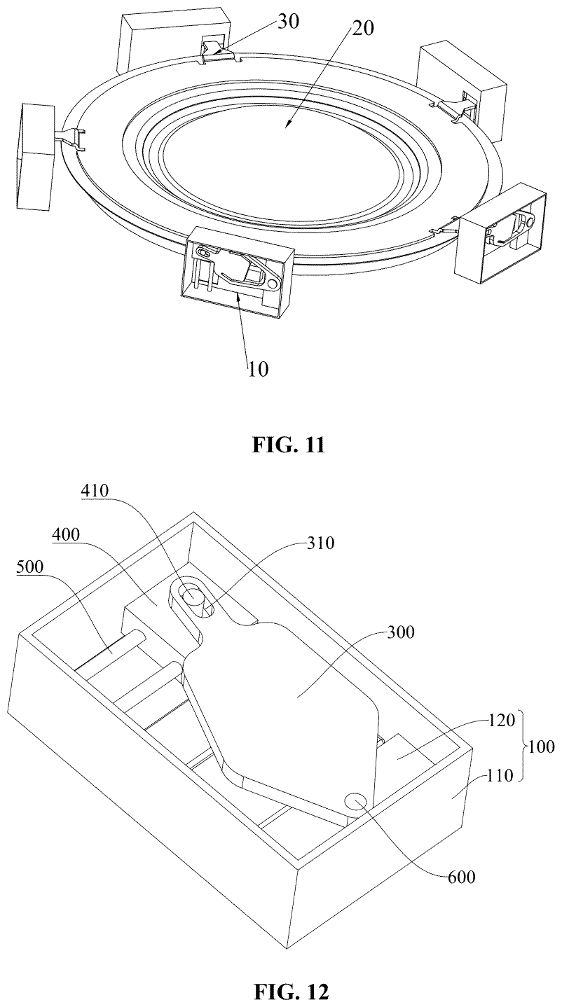

For example, as shown in FIG. 9 to FIG. 11, the electronic device may include a device body 20 and a moving member 30, and the moving member 30 is capable of moving relative to the device body 20. The fixed component 100 of the piezoelectric actuator 10 is arranged on the device body 20, and the moving member 30 is connected to the movable member 400, so that the movable member 400 can drive the moving member 30 to move.

For example, the electronic device can be AR, VR, camera, electronic product, etc., which is not limited in this embodiment. The moving member 30 can be a display component of an electronic product, an optical component (or optical bracket) for generating a zoom function, or a lens (or optical module). In a case where the size of the moving member 30 is large, multiple piezoelectric actuators 10 can be connected to the moving member 30 to improve the stability and reliability of movement.

Beneficial effects of the present application are as follows.

In the piezoelectric actuator and the electronic device provided in the present application, the piezoelectric component has a first friction force, the swing member is provided with the second friction surface abutting against the first friction surface, one end of the swing member is rotatably connected to the fixed component, and the other end of the swing member is movably connected to the movable member. When the piezoelectric component is energized and deformed, the abutting first friction surface and second friction surface can be used to drive the swing member to swing relative to the fixed component, so as to drive the movable member to move through the swing member, thereby realizing indirect driving of the movable member. Since the movable member does not directly contact the piezoelectric component, the movable member has a smaller size, and the movable member does not need to reserve a space greater than one time the stroke for its use. The stroke of the movable member can be just equal to the moving distance required to drive the moving member to move, so that the swing amplitude of the swing member will not be too large, and the required activity space is smaller. In addition, by providing the swing member, the movable member can be located on one side of the piezoelectric component in the length direction of the swing member, so that in the thickness direction of the swing member, the size of the piezoelectric actuator can be smaller, and thus the piezoelectric actuator can have a smaller overall size which meets the miniaturization requirements, and can be used in scenes with smaller installation space, and has a wider range of applications.

### Embodiment Two

The piezoelectric actuator 10 provided in this embodiment is different from that in the embodiment one in that the specific structure is different.

Specifically, in this embodiment, as shown in FIG. 12 to FIG. 14, the piezoelectric actuator 10 further includes a first magnetic member 800 disposed on the fixed component 100. The swing member 300 in this embodiment is made of a magnetic conductive material so as to be able to magnetically cooperate with the first magnetic member 800. The first magnetic member 800 and the piezoelectric component 200 are disposed on the same side of the swing member 300, and the first magnetic member 800 and the piezoelectric component 200 are both in contact with the swing member 300, that is, the first magnetic member 800 and the piezoelectric component 200 are spaced apart in a direction perpendicular to the second direction Y. For example, the piezoelectric component 200 is located between the first magnetic member 800 and the movable member 400.

For example, the first magnetic member 800 can cooperate with of the swing member 300 in a magnetic attraction manner to drive the first friction surface 201 to always abut against the second friction surface 301, so that the piezoelectric component 200 can drive the swing member 300 to swing when the piezoelectric component 200 is powered on.

It should be noted that the magnetic attraction force between the first magnetic member 800 and the swing member 300 is smaller than the friction force between the piezoelectric component 200 and the swing member 300, so that the swing member 300 can be smoothly driven by the piezoelectric component 200.

It is to be noted that in this embodiment, the pre-pressure between the piezoelectric component 200 and the swing member 300 is provided by the first magnetic member 800. Therefore, the piezoelectric actuator 10 may not include the pressing member, and there may be no gap 700 between the second connecting portion 350 and the first surface 121. The specific setting can be made according to practical requirements, which is not limited in this embodiment.

The other structures in this embodiment are similar to the corresponding structures in the first embodiment and have similar beneficial effects as those achieved in the first embodiment, which is not described in detail here.

### Embodiment Three

The piezoelectric actuator 10 provided in this embodiment is different from that in the embodiment one in that the specific structure is different.

Specifically, the piezoelectric actuator 10 in this embodiment further includes a second magnetic member and a third magnetic member. The second magnetic member is arranged on the fixed component 100, and the third magnetic member is arranged on the swing member 300. The second magnetic member and the piezoelectric component 200 are arranged on the same side of the swing member 300. The second magnetic member and the third magnetic member are magnetically attracted and so matched to drive the first friction surface 201 to always abut against the second friction surface 301, so that the piezoelectric component 200 can drive the swing member 300 to swing when the piezoelectric component 200 is powered on.

In this embodiment, the second magnetic member can be arranged on the bottom surface of the housing 110 or embedded in the housing 110, and the third magnetic member can be arranged on the surface of the swing member 300 or embedded in the swing member 300, which is not limited in this embodiment.

It is to be noted that, in this embodiment, the pre-pressure between the piezoelectric component 200 and the swing member 300 is provided by the first magnetic member 800 and the second magnetic member that are attracted to each other. Therefore, the piezoelectric actuator 10 may not include the pressing member, and there may be no gap 700 between the second connecting portion 350 and the first surface 121. The specific configuration can be made according to actual needs, and this embodiment is not limited to this.

The other structures in this embodiment are similar to the corresponding structures in the first embodiment and have similar beneficial effects as those achieved in the first embodiment, and are not described in detail here.

### Embodiment Four

The piezoelectric actuator 10 provided in this embodiment is different from that in the embodiment one, the embodiment two or the embodiment three in that the specific structure of the swing member 300 is different.

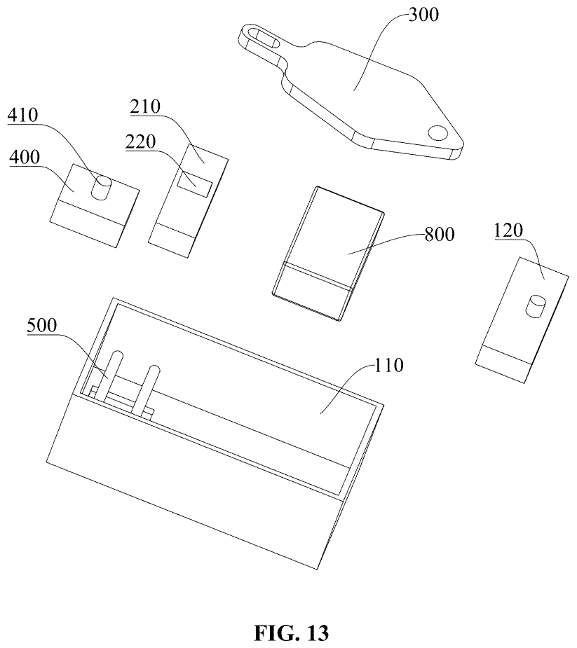

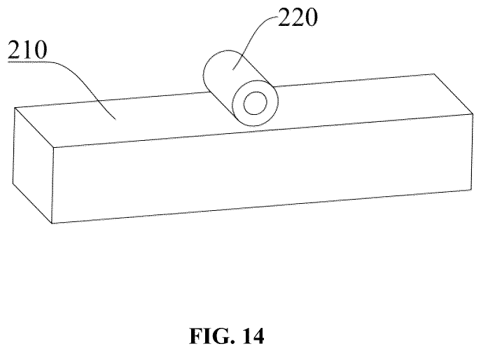

For example, as shown in FIG. 13, the swing member 300 is an integrated plate-like structure, that is, the swing member 300 does not include structures such as the cantilever 340 and the rocker arm 330, and does not have a hollow out portion. By configuring the swing member 300 as an integrated plate-like structure, the swing member 300 can have a higher structural strength.

Optionally, when the swing member 300 is made of a magnetic conductive material and is configured to magnetically attract and match the first magnetic member 800, the swing member 300 is configured as a plate-like structure, which can improve the effect of magnetic attraction between the swing member 300 and the first magnetic member 800.

The other structures in this embodiment are similar to the corresponding structures in the embodiment one, the embodiment two or the embodiment three and have similar beneficial effects as those achieved by the embodiment one, the embodiment two or the embodiment three, which will not be described in detail here.

### Embodiment Five

This embodiment is different from the embodiment one, the embodiment two, the embodiment three or the embodiment four in that the specific structure of the linkage member 220 is different.

Specifically, please refer to FIG. 14. The linkage member 220 in this embodiment is in a cylindrical shape, and the outer peripheral surface of the linkage member 220 is the first friction surface 201. The cylindrical linkage member 220 can also realize the driving of the swing member 300.

For example, the linkage member 220 can be a hollow cylindrical shape to have a light weight, which is conducive to the miniaturization of the piezoelectric actuator 10.

It is to be noted that the above are only preferred embodiments of the present application and the technical principles used. The person skilled in the art will understand that the present application is not limited to the embodiments described herein, and that various obvious changes, readjustments and substitutions can be made by the person skilled in the art without departing from the scope of protection of the present application. Therefore, although the present application has been described in more detail through the above embodiments, the present application is not limited to the above embodiments, and may also include more other equivalent embodiments without departing from the concept of the present application, and the scope of the present application is determined by the scope of the appended claims.

What is claimed is:

1. A piezoelectric actuator, comprising:
a fixed component;
a piezoelectric component, wherein the piezoelectric component is arranged on the fixed component, and the piezoelectric component has a first friction surface;
a swing member, wherein one end of the swing member is rotatably connected to the fixed component, and the swing member is provided with a second friction surface abutting against the first friction surface; and
a movable member, wherein the movable member is movably connected to the other end of the swing member;
wherein the piezoelectric component is configured to drive the swing member to swing relative to the fixed component through the abutting first friction surface and the second friction surface, to drive the movable member to move.

2. The piezoelectric actuator according to claim 1, wherein a first end of the swing member is rotatably connected to the fixed component;
one of the movable member and a second end of the swing member facing away from the first end is provided with a slide slot, the other one of the movable member and the second end of the swing member facing away from the first end is provided with a guide member slidably matched with the slide slot; and
the guide member is slidable in an extension direction of the slide slot, to allow a moving trajectory of the movable member to be a straight line when the swing member rotates.

3. The piezoelectric actuator according to claim 2, wherein the movable member is slidably connected to the fixed component in a first direction, and a position of the rotatable connection of the first end of the swing member to the fixed component is located in the middle of the fixed component in the first direction.

4. The piezoelectric actuator according to claim 3, further comprising a guide structure connected to the fixed component and extending in the first direction, wherein the movable member is provided with a guide matching structure slidably matching the guide structure, and the movable member is slidably arranged on the guide structure through the guide matching structure.

5. The piezoelectric actuator according to claim 4, wherein two ends of the guide structure in the first direction are respectively connected to two side walls of the fixed component opposite to each other in the first direction, the guide matching structure is a sliding hole provided in the movable member, and the guide structure is arranged to enter the sliding hole.

6. The piezoelectric actuator according to claim 1, wherein the swing member comprises a first connecting portion, a rocker arm and a cantilever;
the first connecting portion is movably connected to the movable member;
the rocker arm and the cantilever are connected to a same side of the first connecting portion, and the rocker arm is arranged spaced apart from the cantilever;
one end of the cantilever facing away from the first connecting portion is rotatably connected to the fixed component; and
the second friction surface is arranged on the rocker arm.

7. The piezoelectric actuator according to claim 6, wherein two cantilevers are provided, and the two cantilevers are arranged on opposite sides of the rocker arm;
the swing member further comprises a second connecting portion, ends of the two cantilevers facing away from the first connecting portion are both connected to the second connecting portion; and
the second connecting portion is rotatably connected to the fixed component.

8. The piezoelectric actuator according to claim 7, wherein the fixed component comprises a housing and a fixed part arranged in the housing, the piezoelectric actuator further comprises a rotating shaft arranged on a first surface of the fixed part, and the second connecting portion is sleeved on the rotating shaft and is rotatable around the rotating shaft; and
the swing member has an unassembled state and an assembled state, and when the swing member is in the unassembled state, a gap is present between the second connecting portion and the first surface; and when the swing member is in the assembled state, the piezoelectric actuator further comprises a pressing member, and the pressing member is connected to the housing and is configured to press the second connecting portion to abut against the fixed part, to allow a pre-pressure to present between the rocker arm and the piezoelectric component.

9. The piezoelectric actuator according to claim 8, wherein the fixed component, the piezoelectric component, the swing member and the movable member are all located in the housing; and
a preset wall surface of the housing is provided with a connecting hole, an orthographic projection of the movable member on the preset wall surface at least partially falls into the connecting hole, and the connecting hole is configured for a moving member connected to the movable member to pass through.

10. The piezoelectric actuator according to claim 1, further comprising a first magnetic member arranged on the fixed component, wherein the swing member is made of a magnetic conductive material, the first magnetic member and the piezoelectric component are arranged on a same side of the swing member, and the first magnetic member is magnetically matchable with the swing member to drive the first friction surface to always abut against the second friction surface; or,
further comprising a second magnetic member and a third magnetic member, wherein the second magnetic member is arranged on the fixed component, the third magnetic member is arranged on the swing member, the second magnetic member and the piezoelectric component are arranged on a same side of the swing member, and the second magnetic member and the third magnetic member are magnetically attracted and matched to drive the first friction surface to always abut against the second friction surface.

11. The piezoelectric actuator according to claim 1, wherein the swing member is an integrated plate-like structure.

12. The piezoelectric actuator according to claim 1, wherein the first friction surface is an arc surface.

13. The piezoelectric actuator according to claim 1, wherein the piezoelectric component comprises a piezoelectric member and a linkage member arranged on the piezoelectric member; and
the linkage member is in a cylindrical shape, and an outer peripheral surface of the linkage member is the first friction surface; or, the linkage member has a flat connecting surface parallel to and connected to the piezoelectric member, and the first friction surface is arranged opposite to the flat connecting surface.

14. An electronic device, comprising a piezoelectric actuator comprising:
a fixed component;
a piezoelectric component, wherein the piezoelectric component is arranged on the fixed component, and the piezoelectric component has a first friction surface;
a swing member, wherein one end of the swing member is rotatably connected to the fixed component, and the swing member is provided with a second friction surface abutting against the first friction surface; and
a movable member, wherein the movable member is movably connected to the other end of the swing member;
wherein the piezoelectric component is configured to drive the swing member to swing relative to the fixed component through the abutting first friction surface and the second friction surface, to drive the movable member to move.

15. The electronic device according to claim 14, wherein a first end of the swing member is rotatably connected to the fixed component;
one of the movable member and a second end of the swing member facing away from the first end is provided with a slide slot, the other one of the movable member and the second end of the swing member facing away from the first end is provided with a guide member slidably matched with the slide slot; and
the guide member is slidable in an extension direction of the slide slot, to allow a moving trajectory of the movable member to be a straight line when the swing member rotates.

16. The electronic device according to claim 15, wherein the movable member is slidably connected to the fixed component in a first direction, and a position of the rotatable connection of the first end of the swing member to the fixed component is located in the middle of the fixed component in the first direction.

17. The electronic device according to claim 16, further comprising a guide structure connected to the fixed component and extending in the first direction, wherein the movable member is provided with a guide matching structure slidably matching the guide structure, and the movable member is slidably arranged on the guide structure through the guide matching structure.

18. The electronic device according to claim 17, wherein two ends of the guide structure in the first direction are respectively connected to two side walls of the fixed component opposite to each other in the first direction, the guide matching structure is a sliding hole provided in the movable member, and the guide structure is arranged to enter the sliding hole.

19. The electronic device according to claim 14, wherein the swing member comprises a first connecting portion, a rocker arm and a cantilever;
the first connecting portion is movably connected to the movable member;
the rocker arm and the cantilever are connected to a same side of the first connecting portion, and the rocker arm is arranged spaced apart from the cantilever;
one end of the cantilever facing away from the first connecting portion is rotatably connected to the fixed component; and
the second friction surface is arranged on the rocker arm.

20. The electronic device according to claim 19, wherein two cantilevers are provided, and the two cantilevers are arranged on opposite sides of the rocker arm;
the swing member further comprises a second connecting portion, ends of the two cantilevers facing away from the first connecting portion are both connected to the second connecting portion; and
the second connecting portion is rotatably connected to the fixed component.
